(19) United States
(12) Patent Application Publication
(10) Pub. No.: US 2008/0010238 A1
(43) Pub. Date: Jan. 10, 2008

(54) Index having short-term portion and long-term portion

(75) Inventors: Nicholas A. Whyte, Mercer Island, WA (US); Gaurav Sareen, Bellevue, WA (US); Oren Firestein, Redmond, WA (US); Ronnie I. Chaiken, Woodinville, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/483,041

(22) Filed: Jul. 7, 2006

(51) Int. Cl. G06F 17/30

(52) U.S. Cl. 707/2

(57) ABSTRACT

An index of a search engine includes two portions: a long-term portion that is optimized for lookup performance and is stored in bulk storage, for example, non-volatile memory, and a short-term portion that is easily updatable and is stored solely or primarily in random access memory (RAM). Both portions of the index are searchable. The vast majority of documents in the location space are indexed in the long-term portion in a format optimized for lookup, while new documents are immediately searchable in the easily updatable short-term portion, which has a different format. The long-term portion is updated with indexing information of the short-term portion.

### BACKGROUND

An index is any data structure which enables lookup. A search engine uses the index to respond to a query. The index is thus the catalog of content that is indexed by, or known to, the search engine. The design and analysis of index data structures has attracted a lot of attention. There are complex design trade-offs involving lookup performance, index size, and index update performance.

Large search engines optimize their index build process to create index files on disk that favor lookup performance on the assumption that updates are very infrequent and that updates are usually done in large batches. This optimization does not allow for adding new documents to an index immediately after they are discovered and being able to have search queries include those new documents in a set of search results. Rather, those new documents remain un-indexed until an update has been done, and only then are they available to the search engine for lookup.

Some search engines support immediate searching of new documents, but this hampers the lookup performance. One technique is to frequently write small index files to disk. In some search engines, the writing of small index files occurs every few minutes, resulting in an inordinately large number of small index files to be searched. The index is effectively fragmented, which hampers the lookup performance. Another technique is to use a data structure on disk that is more easily updated, for example, a relational database, but the lookup performance of an index with such a data structure is not as good as that of an index on the disk in a structure that is optimized for lookup performance.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An index of a search engine includes two portions: a long-term portion and a short-term portion. The long-term portion is optimized for lookup performance and is stored in bulk storage, for example, non-volatile memory. The short-term portion is easily updatable and is stored solely or primarily in random access memory (RAM). Some of the indexing information of the short-term portion may be stored in bulk storage. Both portions of the index are searchable. Documents indexed in the long-term portion are indexed in a format optimized for lookup, while new documents are immediately searchable in the easily updatable short-term portion, which has a different format. From time to time, or when the short-term portion has reached a particular size, the long-term portion may be updated with some or all of the indexing information of the short-term portion, and the short-term portion may be cleared partially or entirely to make room for indexing information of other documents to be indexed in the future.

### BRIEF DESCRIPTION OF THE DRAWINGS

Embodiments are illustrated by way of example and not limitation in the figures of the accompanying drawings, in which like reference numerals indicate corresponding, analogous or similar elements, and in which:

FIG. 1 is a block diagram of an exemplary search engine, according to some embodiments of the invention;

FIG. 2 is a flowchart of an exemplary method for handling documents that have not yet been indexed in the index, according to some embodiments of the invention;

FIG. 3 is a flowchart of an exemplary method for searching the index, according to some embodiments of the invention;

FIG. 4 is a flowchart of an exemplary method for updating the index, according to some embodiments of the invention; and

FIG. 5 is a block diagram of an exemplary operating environment in which embodiments of the invention may be implemented.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION

In the following detailed description, numerous specific details are set forth in order to provide a thorough understanding of embodiments of the invention. However it will be understood by those of ordinary skill in the art that the embodiments may be practiced without these specific details. In other instances, well-known methods, procedures and components have not been described in detail so as not to obscure the embodiments of the invention.

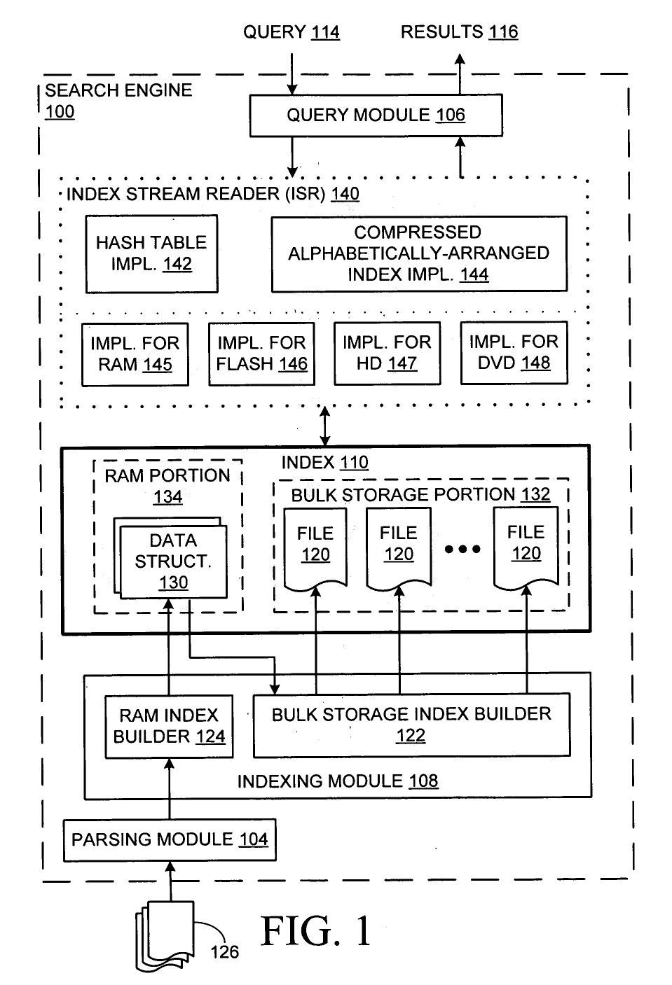

Reference is made to FIG. 1, which is a block diagram of an exemplary search engine, according to some embodiments of the invention. A search engine 100 includes a parsing module 104, a query module 106, an indexing module 108, and an index 110. Index 110 may be distributed, with a complete copy of index 110 spread across many machines. In the following description, index 110 is inverted—basically an ordered list of words and locations, with each word followed by a list of occurrences of that word within a location space. Each occurrence is followed by metadata about the location. Inverted indexes are known to be good for short queries, however, other index types are also contemplated and embodiments of the invention are equally applicable to those other index types. “Location space” may be defined as follows: If all documents in a corpus are laid out end-to-end, the words in those documents can be numbered such that each later word has a higher number than each earlier word. Each of these numbers is the location of that occurrence of that word in that document. The location space is the collection of all such locations in the corpus.

In response to a query 114, search engine 100 searches index 110 and returns a set of results 116. Each result includes an identification of an indexed document that meets the criteria of query 114. An indexed document may be any object having textual content, such as, but not limited to, an e-mail message, a photograph with a textual description or other textual information, clip-art, textual documents, spreadsheets, and the like.

The terms of a query can include words and phrases, e.g. multiple words enclosed in quotation marks. A term may include prefix matches, wildcards, and the like. The terms may be related by Boolean operators such as OR, AND and NOT to form expressions. The terms may be related by positional operators such as NEAR, BEFORE and AFTER. A query may also specify additional conditions, for example, that terms be adjacent in a document or that the distance between the terms not exceed a prescribed number of words.

Query module 106 processes query 114 before index 110 is accessed. Query module 106 may treat issues such as capitalization, punctuation and accents. Query module 106 may also remove ubiquitous terms such as “a”, “it”, “to” and “the” from query 114.

In some search engines, results are ranked by a ranker (not shown) and only the top N results are provided to the user. The ranker may be incorporated in or coupled to query module 106. In some search engines, a result includes a caption, which is a contextual description of the document identified in the result. Other processing of the results is also known, including, for example, removing near duplicates from the results, grouping results together, and detecting spam.

Index 110 includes one or more files 120 stored in bulk storage. A non-exhaustive list of examples for bulk storage includes optical non-volatile memory (e.g. digital versatile disk (DVD) and compact disk (CD)), magnetic non-volatile memory (e.g. tapes, hard disks, and the like), semiconductor non-volatile memory (e.g. flash memory), volatile memory, and any combination thereof. Files 120 may be distributed among more than one type of bulk storage and among more than one machine.

Files 120 contain indexing information of documents in a format that is optimized for lookup performance. For example, files 120 may include a compressed alphabetically-arranged index. Several techniques for compressing an index are known in the art. What constitutes a format that is optimized for lookup performance may depend upon the type of bulk storage that stores files 120. For example, reading from a DVD is different than reading from a hard disk. Lookup performance may be enhanced if the amount of space occupied by the index is reduced. Indexing module 108 therefore includes a bulk storage index builder 122 for generating, updating and possibly merging files 120.

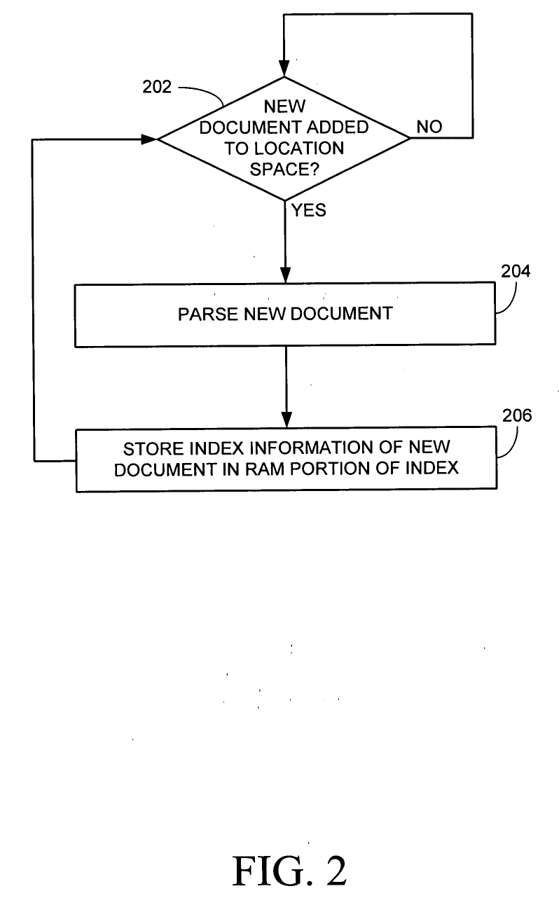

Indexing module 108 also includes a random-access memory (RAM) index builder 124. Reference is made briefly to FIG. 2, which is a flowchart of an exemplary method according to some embodiments of the invention for handling “new” documents 126—i.e. documents that have not yet been indexed in index 110. The method of FIG. 2 is performed by parsing module 104 and RAM index builder 124. As or after one or more new documents 126 are added to the location space (checked at 202), they are parsed by parsing module 104 at 204. The new documents 126 may be added to the same location space as the documents indexed in the long-term index, or in a separate location space. Using the output of parsing module 104, RAM index builder 124 indexes each document 126 and at 206 stores the indexing information in one or more data structures 130. Data structures 130 are stored solely or primarily in RAM. Some data structures 130 may stored in bulk storage. Data structures 130 may be distributed among more than one machine.

Data structures 130 are searchable by search engine 100, so that documents 126 can be identified in the results to a query, if appropriate. The format of the indexing information in data structures 130 differs from that in files 120. While the format of the indexing information in files 120 is optimized for lookup performance, the format of the indexing information in data structures 130 may be designed for other considerations. For example, the format may be designed for one or a combination of lookup performance, the ease with which it is updated, the ease with which its indexing information is converted into the format of the indexing information in files 120, and reducing the amount of memory required to store data structures 130. For example, data structures 130 may include an uncompressed hash table index. Each key is a hash of a word, and the element corresponding to the key is an array of locations indicating where the word can be found in the location space of documents. The array of locations might be sorted or might not be sorted.

For example, if the two documents currently indexed in data structures 130 have the texts “My bicycles have six gears.” and “We have six bicycles for sale.”, respectively, then the hash table may have the following content:

| key | locations |
|---|---|
| hash(“bicycles”) | 2, 9 |
| hash(“for”) | 10 |
| hash(“gears”) | 5 |
| hash(“have”) | 3, 7 |
| hash(“My”) | 1 |
| hash(“sale”) | 11 |
| hash(“six”) | 4, 8 |
| hash(“We”) | 6 |

where the locations refer to the order of the words in the documents when concatenated. In some embodiments, the documents indexed in data structures 130 will have their own separate location space. In other embodiments, however, the locations in the hash table will refer to the entire location space, not just the subset of the location space in which the documents indexed in the hash table are located.

Index 110 therefore comprises two portions: a portion 132 that is optimized for lookup performance and is stored in bulk storage such as non-volatile memory, and a portion 134 that is easily updatable and is stored solely or primarily in RAM.

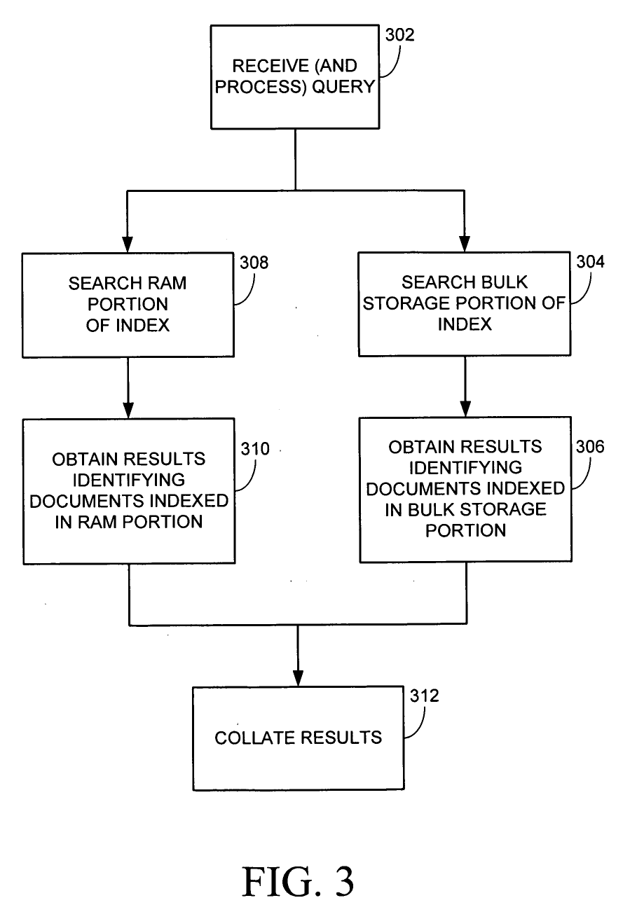

Reference is now made briefly to FIG. 3, which is a flowchart of an exemplary method for searching index 110, according to some embodiments of the invention. At 302, query module 106 receives and possibly processes query 114. At 304, query module 106 searches the bulk storage portion 132 of index 110 to find instances of the sought-for words, and at 306, query module 106 receives results corresponding to documents indexed in bulk storage portion 132. For example, if query 114 is to search for documents including the word “bicycles”, then documents indexed in files 120 that include this word are identified in the results obtained at 306. Similarly, at 308, query module 106 searches the RAM portion 134 of index 110 to find instances of the sought-for words, and at 310, query module 106 receives results corresponding to documents indexed in RAM portion 134. To continue the “bicycles” example, documents which are not yet indexed in files 120 but are indexed in data structures 130 and that include the word “bicycles” are identified in the results obtained at 310. The search at 308 may occur before, during or after the search at 304. Since the bulk storage portion 132 of index 110 is optimized for lookup, the results obtained at 306 may be obtained quickly. Since the RAM portion 134 of index 110 stored in data structures 130 is stored in RAM, the results obtained at 310 may be obtained quickly. At 312, query module 106 collates the results from both portions of index 110.

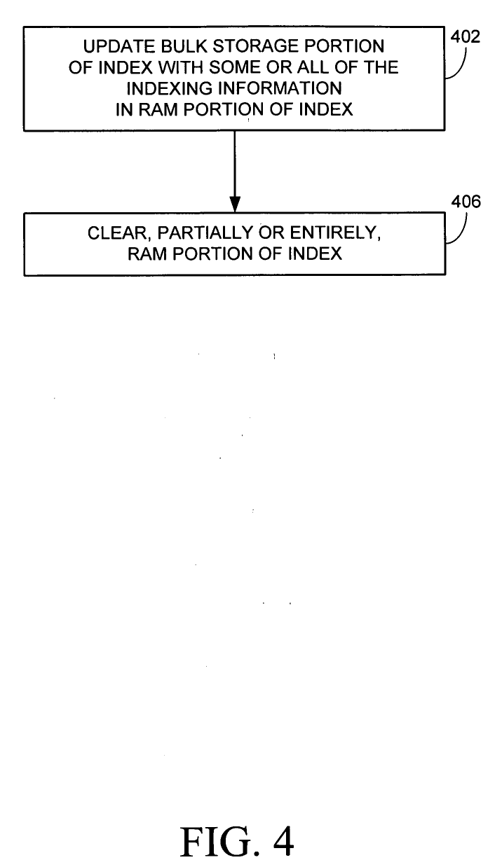

Reference is now made briefly to FIG. 4, which is a flowchart of an exemplary method performed by index builder 122. At 402, index builder 122 may update the bulk storage portion 132 of index 110 with some or all of the indexing information in data structures 130. Prior to the update, this indexing information is not found anywhere in portion 132. This incorporation is accomplished through the modification of one or more existing files 120, or through the generation of yet another file 120, or both.

For example, portion 134 may be organized into chunks, each of which contains indexing information for up to 65,536 documents. Bulk storage portion 132 may be updated with indexing information from one chunk at a time, and only that one chunk is cleared afterwards. The other chunks remain in portion 134 until they are also transferred to bulk storage portion 132. Conversion of a chunk of portion 134 may involve sorting the hash table alphabetically (thus making it no longer a hash table), compressing each term in the table and adding it to the growing file. Additional information about each document and the index as a whole may also be added to the file, as well as additional data structures useful in looking up terms from a bulk-storage index. Once this chunk file has been created, it may serve as another file 120, or may be merged with other bulk-storage files 120.

This update may be triggered by indexing module 108 under various circumstances, for example, once a predetermined period of time has elapsed since a most recent update of bulk storage portion 132 with some or all of the information in portion 134, or once data structure 130 exceeds a predetermined size, or based on the intended use of the documents indexed in the chunk being transferred. Once bulk storage portion 132 has been successfully updated, data structures 130 may be cleared, partially or entirely, at 406 to make room for indexing information of documents that will be added to the location space in the future.

The compression of an alphabetically-arranged index may involve compression of the words that are the key to the index. For example, all words starting with the prefix “bi” may be listed in the index following the prefix, but without the prefix. Similarly, plural forms of words may be listed in the index following the singular form of the word, with just “s ” or “es” as appropriate. So the word “bicycles” may be found in the index by the key “s” that follows the key “cycle” that follows the key “bi”. One possibility for updating portion 132 with the indexing information of data structures 130 will be to include in the part of the index of portion 132 for “bicycles” the locations of that word corresponding to their occurrence in the documents that were indexed in data structures 130.

Bulk storage portion 132 may therefore also be considered a long-term portion of index 110 that is optimized for lookup performance, and RAM storage portion 134 may be considered a short-term portion of index 110 that is easily updatable. The vast majority of documents in the location space are indexed in the long-term portion in a format optimized for lookup, while new documents, once indexed by RAM index builder 124, are immediately searchable in the easily updatable short-term portion. The more RAM available to the search engine, the less frequently updates to bulk storage portion 132 need to be made. Fewer updates to bulk storage portion 132 may preserve optimized lookup performance, for example, by avoiding unnecessary fragmentation of index 110 and by avoiding excessive numbers of files 120. For example, a basic personal computer (PC) upgraded with additional RAM may be a suitable operating environment in which to implement embodiments of this invention.

In some search engines, portion 132 may have two or more tiers. For example, certain documents most likely to be identified in results of a query are indexed in a small tier of portion 132 that is stored in memory to enhance lookup performance. The rest of the documents indexed in portion 132 are indexed in one or more larger tiers that are stored in other forms of bulk storage, for example, HDD and DVD. The format of the indexing information in the small tier is identical to that of the larger tiers.

In some search engines, access to index 110 may be provided via an abstraction layer known as an index stream reader (ISR) 140. ISR 140 does the actual work of searching through index 110, and may be invoked by query module 106 for the searching described above with respect to FIG. 3. ISR 140 may present an interface to query module 106 with functionality such as “find all documents that have word X”, “get next document ”, “find all documents that have phrase Y”, and similar index access functionality. Query module 106 then processes the output returned by ISR 140 to generate the results, for example, by implementing intersections and/or unions when query 114 has Boolean operators.

ISR 140 provides a level of abstraction to make the format of index 110 transparent to any modules that make use of its functionality. ISR 140 therefore includes various components to implement access to an index (or portion thereof) in various formats, including, for example, a hash table implementation 142 and a compressed alphabetically-arranged index implementation 144. Similarly, ISR 140 provides a level of abstraction to make the type of storage media where index 110 is stored transparent to any modules that make use of its functionality. ISR 140 therefore includes various components to implement access to an index (or portion thereof) stored in various types of storage media, including, for example, a RAM implementation component 145 and one or more non-volatile memory implementation components. The non-volatile memory implementation components may include, for example, a flash memory implementation component 146, a hard disk implementation component 147 and a DVD implementation component 148. The foregoing description of ISR 140 is merely an example, and other internal architectures for ISR 140 are also contemplated.

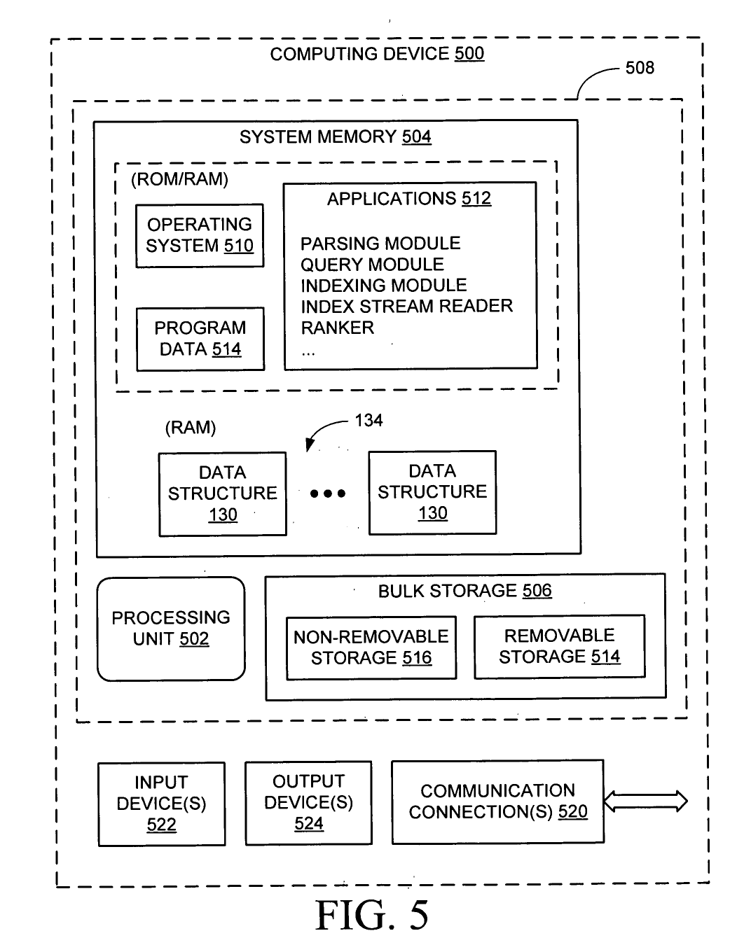

FIG. 5 illustrates an exemplary system for implementing embodiments of the invention, the system including one or more computing devices, such as computing device 500. The terms “computing device” and “computer” not only include mainframes, servers and personal computers (e.g., desktop, laptop and notebook computers), but also other devices capable of processing data, such as PDAs (personal digital assistants), mobile telephones (e.g. smartphones), set-top boxes, gaming consoles, handheld gaming devices, and embedded computing devices (e.g. computing devices built into a car or ATM (automated teller machine)).

In its most basic configuration, device 500 typically includes at least one processing unit 502, system memory 504, and bulk storage 506. This most basic configuration is illustrated in FIG. 5 by dashed line 507. System memory 504 includes a volatile portion (such as RAM) in which portion 134 of index is stored. For example, the volatile portion of system memory 504 may have one or more data structures 130 therein. Depending on the exact configuration and type of computing device, the rest of system memory 504 may be volatile (such as RAM)), non-volatile (such as read-only memory (ROM), flash memory, etc.) or some combination of the two. System memory 504 typically includes an operating system 510, one or more applications 512, and may include program data 514. In some embodiments, applications 512 may include a parsing module, a query module, an indexing module, an index stream reader, and a ranker.

Bulk storage 506 may provide additional storage (removable and/or non-removable), including, but not limited to non-volatile memory such as magnetic or optical disks or tape. Such additional storage is illustrated in FIG. 5 by removable storage 514 and non-removable storage 516. Portion 132 of index 110 may be stored anywhere in bulk storage 506.

Computer storage media includes volatile and nonvolatile, removable and non-removable media implemented in any method or technology for storage of information such as computer readable instructions, data structures, program modules or other data. Memory 504, removable storage 514 and non-removable storage 516 are all examples of computer storage media. Computer storage media includes, but is not limited to, RAM, ROM, electrically erasable programmable ROM (EEPROM), flash memory or other memory technology, compact disk ROM (CD-ROM), DVD or other optical storage, magnetic cassettes, magnetic tape, magnetic disk storage or other magnetic storage devices, or any other medium which can be used to store the desired information and which can be accessed by computing device 500. Any such computer storage media may be part of device 500.

Additionally, device 500 may also have additional features or functionality. For example, Device 500 may also contain communication connection(s) 520 that allow the device to communicate with other devices. Communication connection(s) 520 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media. The term computer readable media as used herein includes both storage media and communication media.

Device 500 may also have input device(s) 522 such as keyboard, mouse, pen, voice input device, touch input device, etc. Output device(s) 524 such as a display, speakers, printer, etc. may also be included. All these devices are well known in the art and need not be discussed at length here.

As described above, index 110 may be distributed, and hence files 120 and/or data structures 130 may be distributed over more than one computing device. Moreover, the various components of search engine 100 need not be on the same computing device.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
indexing documents in the short term in one or more data structures designed, at least in part, for the ease with which said one or more data structures are updated; and
indexing said documents for the long term in one or more files optimized for lookup performance,
wherein indexing information in said one or more data structures is in a different format than indexing information in said one or more files.

2. The method of claim 1, further comprising:
searching, in response to a query, said one or more data structures and said one or more files.

3. The method of claim 1, wherein said one or more files are distributed among more than one machine.

4. The method of claim 1, wherein said one or more data structures are distributed among more than one machine.

5. The method of claim 1, wherein said data structures are in the form of a hash table.

6. A computer-readable medium having computer-executable modules comprising:
an indexing module to index in a first portion of an index one or more documents that were previously un-indexed in said index; and
a query module to search, in response to a query, both said first portion and a second portion of said index that is stored in bulk storage,
wherein indexing information of said second portion has a different format than that of said first portion.

7. The computer-readable medium of claim 6, wherein said first portion is stored solely in random access memory.

8. The computer-readable medium of claim 6, wherein said first portion is stored primarily in random access memory.

9. The computer-readable medium of claim 6, wherein said indexing module is to update said second portion with at least some of the indexing information for said one or more documents and to clear at least part of said first portion.

10. The computer-readable medium of claim 7, wherein said indexing module is to trigger said update of said second portion once a predetermined period of time has elapsed since a most recent update of said second portion.

11. The computer-readable medium of claim 7, wherein said indexing module is to trigger said update of said second portion once said first portion exceeds a predetermined size.

12. The computer-readable medium of claim 7, wherein said indexing module is to trigger said update of said second portion according to an intended use of documents indexed in said first portion.

13. A computing environment comprising:
one or more processing units;
random access memory coupled to one or more of said processing units, said random access memory having stored therein one or more data structures to store a first portion of an index;
bulk storage coupled to one or more of said processing units, said bulk storage having stored therein a second portion of said index in a different format than that of said first portion; and
memory to store computer-executable instructions which, when executed by one or more of said processing units, implement a search engine to generate and search said index.

14. The computing environment of claim 13, wherein said bulk storage comprises volatile memory.

15. The computing environment of claim 13, wherein said bulk storage comprises non-volatile memory.

16. The computing environment of claim 15, wherein said non-volatile memory comprises magnetic non-volatile memory.

17. The computing environment of claim 15, wherein said non-volatile memory comprises optical non-volatile disks.

18. The computing environment of claim 13, wherein said one or more data structures are distributed over more than one computing device.

19. The computing environment of claim 13, wherein said second portion of said index is distributed over more than one computing device.
